(19) United States
(12) Patent Application Publication
(10) Pub. No.: US 2024/0160979 A1
(43) Pub. Date: May 16, 2024

(54) CIRCUIT CUTTING FOR QUANTUM SIMULATION WITH RESOURCE USAGE PREDICTION

(71) Applicant: Dell Products L.P., Round Rock, TX (US)

(72) Inventors: Rômulo Teixeira de Abreu Pinho, Niterói (BR); Miguel Paredes Quiñones, Campinas (BR)

(21) Appl. No.: 18/345,154

(22) Filed: Jun. 30, 2023

Related U.S. Application Data
(60) Provisional application No. 63/383,312, filed on Nov. 11, 2022.

(51) Int. Cl. G06N 10/20; G06N 10/80

(52) U.S. Cl. CPC G06N 10/20; G06N 10/80

(57) ABSTRACT

Cutting quantum circuits is disclosed. Solutions to a cutting problem of cutting a quantum circuit into quantum subcircuits are represented in a tree structure. Selected nodes are queried using a machine learning model to generate predicted resource requirements and/or a predicted execution time. If the prediction associated with a node fails such that the predicted resource requirements and/or execution time in a simulated quantum computing system are greater than threshold resource requirements or a threshold execution time, the corresponding solutions represented by the node and the node's children are pruned from the tree structure.

### RELATED APPLICATIONS

This application is related to U.S. Ser. No. 17/648,065 filed Jan. 14, 2022, and entitled INTELLIGENT ORCHESTRATION OF CLASSIC-QUANTUM COMPUTATIONAL GRAPHS, which application is incorporated by reference in its entirety.

### FIELD OF THE INVENTION

Embodiments of the present invention generally relate to quantum computing and to orchestrating quantum workloads. More particularly, at least some embodiments of the invention relate to systems, hardware, software, computer-readable media, and methods for cutting quantum circuits for quantum simulations with resource usage predictions.

### BACKGROUND

Executing quantum circuits in quantum computing systems can be both complicated and time consuming for a variety of different reasons. For example, the quantum circuit may be too large for available quantum hardware. Further, even if the necessary quantum hardware exists, the quantum circuit may need to wait until the resources are free.

More specifically, several difficulties exist with regard to quantum computing. When using real quantum hardware, the number of qubits is often limiting and, from a practical perspective, cannot execute quantum circuits with more qubits. Further, larger quantum hardware (comparatively more qubits) may be less accurate compared to quantum hardware with fewer qubits.

There are also problems associated with simulated quantum systems. As the complexity of a quantum circuit increases (e.g., more qubits required), the amount of resources required in the simulated quantum system increases exponentially. These issues complicate the ability to effectively and efficiently use quantum computing systems, whether real or simulated.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of orchestrating the execution of quantum jobs and of executing quantum jobs;

FIG. 2 discloses aspects of executing a quantum job;

FIG. 3 discloses aspects of orchestrating the execution of quantum jobs;

FIG. 4 discloses aspects of pruning solutions to a cutting problem; and

FIG. 5 discloses aspects of a method for performing a cutting operation.

### DETAILED DESCRIPTION OF SOME EXAMPLE EMBODIMENTS

Embodiments of the present invention generally relate to real and/or simulated quantum computing systems and operations performed when executing quantum workloads. More particularly, at least some embodiments of the invention relate to systems, hardware, software, computer-readable media, and methods for orchestrating quantum jobs (i.e., quantum workloads) that may include quantum circuit(s). More specifically, embodiments of the invention relate to cutting quantum circuits into quantum subcircuits (each a quantum circuit on its own) in a manner that accounts for resource consumption or resource requirements. Quantum circuits may be executed in simulated quantum systems (e.g., virtual quantum systems or units (vQPUs)) that include classical computing components (e.g., processors, memory) or real quantum hardware systems or units (QPUs).

More specifically, the execution of quantum jobs often requires both classical computing systems and quantum computing systems because several operations are performed. Some of the operations are performed in classical computing systems and some of the operations are performed in quantum computing systems, whether real or simulated. Embodiments of the invention relate to orchestrating the operations performed in classical computing systems and in quantum computing systems.

In one example, a quantum job, which includes a quantum circuit, may be received at an orchestration engine that is configured to orchestrate the execution of the quantum job. Orchestrating the execution of the quantum circuit includes performing actions or operations such as, but not limited to, transpilation operations, cutting operations, and knitting operations. These operations are orchestrated as necessary and in the appropriate order.

Transpilation or a transpilation operation is the process of converting the quantum circuit received by the orchestration engine into a circuit that matches the topology of a target quantum system. Circuit cutting or a cutting operation is the process of dividing a quantum circuit into quantum subcircuits. Circuit cutting provides several benefits. As previously stated, the amount of classical computing resources required to simulate a quantum system increases exponentially as the size of the quantum circuit increases. Because the quantum subcircuits are smaller, the amount of resources required to execute a smaller circuit is decreased. Knitting operations include reconstructing the outputs or results of executing the quantum subcircuits in quantum computing systems in order to determine the output of the original quantum circuit. Knitting operations are also resource intensive.

When orchestrating the execution of quantum circuits, attempts to optimize some of these quantum related operations (e.g., transpilation, cutting, knitting) may generate conflicts. For example, knitting operations become complex and resource intensive as the number of circuits to be knit together increase. As a consequence, one aspect of optimizing knitting operations is to reduce the number of quantum subcircuits to be knitted together. In contrast to optimizing knitting operations, increasing the number of quantum subcircuits is beneficial for cutting operations because smaller quantum subcircuits consume or require fewer computing resources.

Embodiments of the invention thus relate to intelligently orchestrating operations such as cutting operations, knitting operations, transpilation operations, and/or execution operations. Embodiments of the invention further relate to cutting operations that account for resource consumption or resource requirements.

Embodiments of the invention more specifically relate to orchestrating the execution of a quantum circuit and more specifically orchestrating and/or performing cutting operations. When a cutting operation is performed, the original quantum circuit is divided or cut into smaller quantum circuits (quantum subcircuits). However, performing a cutting operation is a combinatorial optimization problem (the cutting problem) that may consume substantial resources.

Embodiments of the invention relate to performing a cutting operation or aspects of a cutting operation by accounting for the amount of resources required for a given solution to the cutting problem. In one example, the potential solutions of the cutting problem may be represented as a directed graph or a tree. Using a branch and bound approach, solutions and solutions derived therefrom that are not satisfactory (e.g., do not meet resource requirements) may be pruned from the graph or tree. This can substantially reduce the potential solutions to the cutting problem and reduce the resources and time required to identify a suitable solution to the cutting problem.

More specifically, a given solution to the cutting problem can be input to a machine learning model to predict the amount of computing resources required (e.g., processors, memory, GPU) and the execution time. If these predictions are above a threshold, the solution fails and may be pruned from the solution tree.

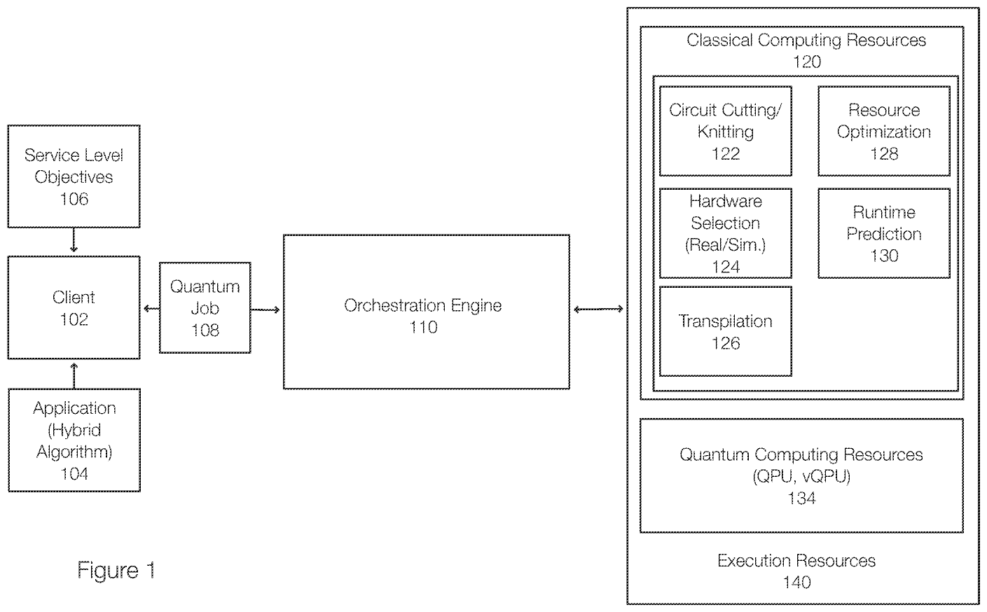

FIG. 1 discloses aspects of orchestrating a quantum job. In one example, a quantum job may be generated by a hybrid application 104. The hybrid application 104 is an application that may require the use of both classical computing resources 120 and quantum computing resources 134. The orchestration of the quantum job may be performed by an orchestration engine and as previously stated, some aspects of the quantum job may be executed in classical computing systems and other aspects may be executed in quantum environments (simulated or real). When quantum computing resources are required, the hybrid application 104 may generate and submit a quantum job 108 to the orchestration engine 110. Results of executing the quantum job may be returned to the client 102. Other aspects of the hybrid application 104 that do not require quantum computing may be performed in classical computing systems with or without the aid of the orchestration engine.

In FIG. 1, a client 102 (e.g., a computing device that may receive user input) may submit a quantum job 108, which may be associated with service level objectives 106 and a hybrid application 104, to an orchestration engine 110. The orchestration engine 110 is configured to orchestrate the execution of the quantum job 108 in accordance with the service level objectives 106.

The orchestration engine 110 may orchestrate the operations involved in executing the quantum job. The actions or operations orchestrated by the orchestration engine 110 may include circuit cutting/knitting 122, resource optimization 128, hardware selection 124, runtime prediction 130, transpilation 126 or the like or combination thereof. The orchestration engine 110 may have access to execution resources 140, which may include classical computing resources 120 (e.g., servers, nodes, containers, clusters, virtual machines) that include processors, memory, and the like. The execution resources 140 may also include quantum computing resources 134 (real or simulated).

Orchestrating the execution of the quantum job 108 may include managing the stages of executing the quantum job. In effect, the orchestration engine 110 may guide the quantum job 108 through a quantum pipeline such that the output of each stage is directed to the input of the next stage. Examples of stages or operations that may be performed on a quantum job include cutting, transpilation, knitting, resource optimization, runtime prediction, or the like.

Once the quantum circuit or quantum subcircuits are prepared for execution, these circuits are deployed to or placed in the quantum computing resources 134, which may be simulated or real. The results of executing the quantum circuits in the quantum computing resources 134 may also be collected by the orchestration engine 110 and returned to the client 102.

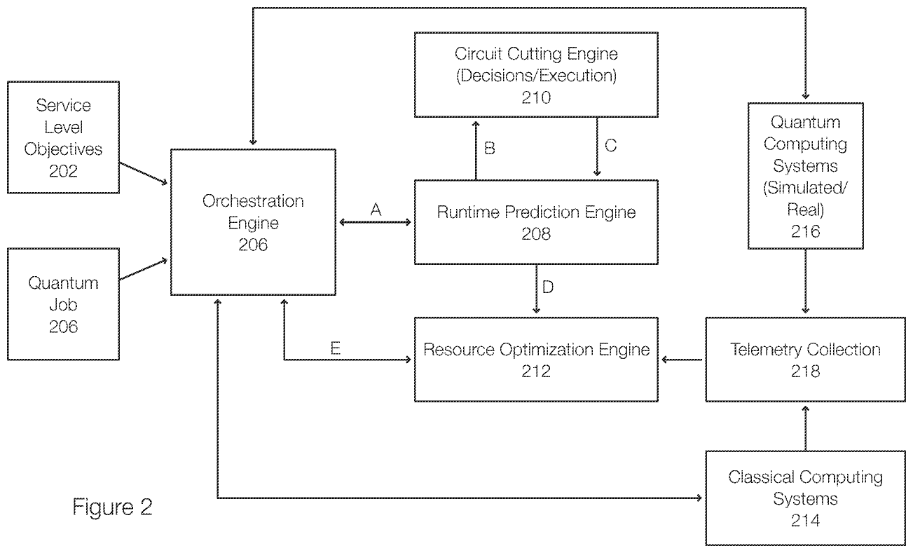

FIG. 2 discloses aspects of orchestrating a quantum job. In FIG. 2, an orchestration engine 206 receives a quantum job 206 and associated service level objectives 202. At A, the orchestration engine 206 may submit an original quantum circuit included in the quantum job 206 to a runtime prediction engine 208. The runtime prediction engine 208 may predict or estimate runtime characteristics such as, but not limited to, resources required to execute the original quantum circuit in a simulated quantum system or a real quantum system, time required to execute the original quantum circuit in a simulated or real quantum system, or the like. If feasible, based on the runtime prediction, the original quantum circuit may simply be executed, which may avoid the cost of various operations including cutting operations and knitting operations.

The runtime prediction engine 208 may represent, include, or have access to one or more machine learning models that are configured or trained to estimate various aspects of executing quantum circuits such as resource requirements and execution times. The machine learning model or models included in the runtime prediction engine 208 may be trained using historical executions of quantum jobs in different types of simulated and/or real quantum computing systems. More specifically, the runtime prediction 208 may include models trained to estimate or predict the runtime characteristics of simulated quantum execution operations, real quantum execution operations, cutting operations, or the like.

At B, the original quantum circuit may be evaluated for cutting purposes. The circuit cutting engine 210 may also use the runtime prediction engine 208, which may also be configured to predict a success rate, resource consumption, and execution time related to a cutting operation. These predictions or estimates may be used in determining whether the quantum circuit should be cut.

Thus, the runtime prediction engine 208 generates output that can be used to determine whether there are enough resources to execute the original quantum circuit within the boundaries of the service level objectives 202. The circuit cutting engine 210 may generate an output that determines whether cutting the original quantum circuit may improve the overall system performance or service-level objectives. The circuit cutting engine 210 may also represent a cutting mechanism configured to cut the original quantum circuit into quantum subcircuits when a decision to cut the original quantum circuit is made.

If the quantum circuit is cut into quantum subcircuits, the runtime prediction engine 208 is used to generate estimated or predicted runtime characteristics for each of the quantum subcircuits.

At D, a resource optimization engine 212 performs resource optimization for either the original quantum circuit or, if the circuit was cut or is planned to be cut, for each of the resulting quantum subcircuits. Optimizing resources may be based, in part, on telemetry collection 218, which includes telemetry information collected from the quantum computing systems 216 and the classical computing systems 214, which are examples of the execution resources 140 used by the orchestration engine 206 when orchestrating the execution of a quantum job. The resource optimization engine 212 uses the collected telemetry data and the predicted runtime characteristics for the quantum circuit or for each of the quantum subcircuits to generate an execution plan at E. The orchestration engine 206 then performs or implements the execution plan that allows resources (e.g., the quantum computing systems 216 and/or classical computing systems 214) to be allocated/used in an intelligent manner that is based on runtime characteristics of the quantum circuit or the quantum subcircuits, current telemetry data and/or service level objectives.

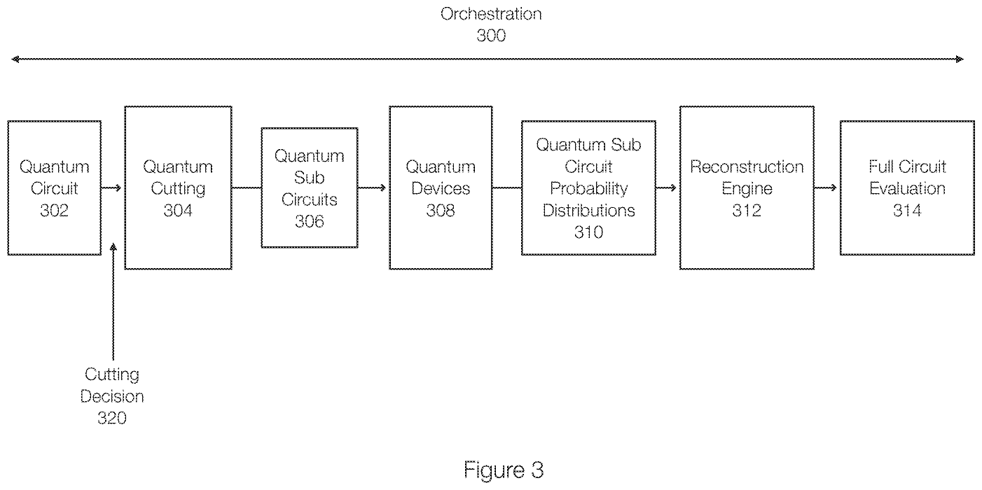

FIG. 3 discloses aspects of orchestrating the execution of a quantum circuit and illustrates examples of orchestration actions or operations. In FIG. 3, an orchestration engine performs orchestration 300 that may be performed from receipt of a quantum job or circuit to providing results of executing the quantum circuit. A quantum circuit 302 is provided to quantum cutting 304. When cutting the quantum circuit 302 at quantum cutting 304, a cutting decision 320 is performed.

The cutting decision 320 includes evaluating the solutions to the cutting problem on a tree structure. This structure allows solutions to the cutting problem to be eliminated or pruned from the tree. For example, a node of the tree, which represents a solution, can be evaluated using a runtime prediction engine. The runtime prediction engine may be a machine learning model configured to predict or estimate resource consumption and/or execution time required to cut the original quantum circuit. If the estimate fails (the runtime prediction generated by the runtime prediction engine, for example, is above a threshold), the solution (a particular node in the tree or solution structure) and all solutions derived from that solution (the children nodes) can be pruned from the solution tree. Thus, the cutting operation is integrated with resource usage predictions to reduce the number of solutions in the solution set.

In one example, the solutions in the tree are evaluated for execution in a simulated quantum computing system to determine or estimate the classical computing resource requirements needed to execute the quantum circuits. The solution of a node may represent multiple circuits or subcircuits. The solution is accepted or rejected based on the quantum subcircuit with the highest resource requirement estimation. In one example, if the runtime prediction for one of the quantum subcircuits in a particular solution is estimated to require resources or time that are above threshold levels, the solution fails and may be pruned.

Cutting the quantum circuit 302 generates quantum subcircuits 306 that are executed at quantum devices 308 (real or simulated). Once the quantum subcircuits 306 are generated, runtime prediction is performed on each of the quantum subcircuits 306 such that resource optimization 322 can be performed. Once an execution plan is generated and resources are optimized, the quantum subcircuits 306 are submitted to the quantum devices 308 (real and/or simulated) in accordance with the execution plan. The outputs of the executions may include quantum subcircuit probability distributions 310.

Executing a quantum circuit is often performed by executing the circuit in a quantum device for a predetermined number of shots. The output is a collection of shot results which reflect an underlying probability distribution. Thus, the outputs of executing the quantum subcircuits includes the probability distributions 310.

Next, a knitting process is performed by a reconstruction engine 312. The reconstruction engine 312 combines the outputs (e.g., the various probability distributions) of executing the quantum subcircuits 306 to determine the output (the probability distribution) of the original quantum circuit 302. This allows an evaluation 314 of the full or original quantum circuit to be performed. The results or evaluation can be returned to the client or to the hybrid application.

Quantum computing systems may have limits relating to circuit depth and/or number of qubits. As a result, execution of a quantum circuit may require circuit cutting operations to generate quantum subcircuits. Performing a cutting operation allows a large quantum circuit to be executed across different quantum computing systems, which may include both real and simulated quantum computing systems.

Due to the limited availability of quantum systems and to constraints of NISQ (Noisy Intermediate-Scale Quantum) devices and for other reasons, simulated quantum computing systems running on classical infrastructures continue to have an important role in the evaluation of quantum circuits or algorithms and on the improvement of quantum devices themselves. Nonetheless, running quantum circuits on simulation engines is limited by the amount of classical resources available. Because resource consumption tends to grow exponentially with the number of qubits, large HPC (High Performance Computing) infrastructures may be used to execute quantum circuits or algorithms and these systems may only be able to run quantum circuits or algorithms that only have a few dozen qubits. Even if these systems can execute larger quantum circuits, the execution time may be exceedingly long and, as such, impractical.

Circuit cutting is a tool or operation that enables the execution of quantum circuits on vQPUs or QPUs. By cutting a large quantum circuit into smaller quantum subcircuits, a larger spectrum of applications and circuits can be executed. Cutting a quantum circuit is typically a combinatorial problem that scales exponentially using classical computing resources. Often, cutting operations are implemented via optimization heuristics that aim to find good solutions for cutting the quantum circuits through the optimization to some metric of quality. In embodiments of the invention, a method is disclosed in which a cutting algorithm considers how much or many computational resources a quantum subcircuit is likely to consume. This facilitates the orchestration of quantum circuit execution.

In addition to generating quantum subcircuits to run on quantum computing systems, embodiments of the invention also improve or optimize the quantum subcircuits for simulated quantum computing systems or simulation engines.

Cutting circuits to run on a quantum computing system may include determining the maximum number of qubits supported by the quantum system. Further, resource consumption patterns of those quantum circuits on simulation engines are not straightforward. Although resource consumption usually scales exponentially with respect to the number of qubits, different quantum circuits may consume or require different amounts of resources. These patterns may depend on the characteristics of how the underlying quantum simulation engine or system is implemented.

In addition to cutting quantum circuits, it may also be necessary to perform post processing (e.g., knitting operations) on the results of the executed quantum subcircuits. Knitting operations are costly when executed with classical algorithms on classical hardware and the complexity of knitting operations increases exponentially with the number of quantum circuits to knit after the quantum circuits are executed.

From a knitting perspective, circuit cutting aims to minimize the number of cuts so that the resulting quantum subcircuits achieve the maximal possible size supported by the target hardware. To the contrary, running smaller quantum subcircuits is beneficial in terms of resource consumption and parallelization of executions, which would favor cutting solutions that generate more quantum subcircuits from the original quantum circuit. Thus, cutting circuits can be complicated and may have conflicting objectives compared to the knitting operations. These conflicting objectives can complicate the optimization process.

Embodiments of the invention separate the optimization cutting problem from the postprocessing (e.g., knitting) operations. Circuit cutting can be viewed as a combinatorial optimization problem that seeks to minimize the computational burden of postprocessing the cuts. Quantum circuits can be represented as directional acyclic graph (DAG) representations, where vertices correspond to gates (operations) and directed edges correspond to qubit dependencies.

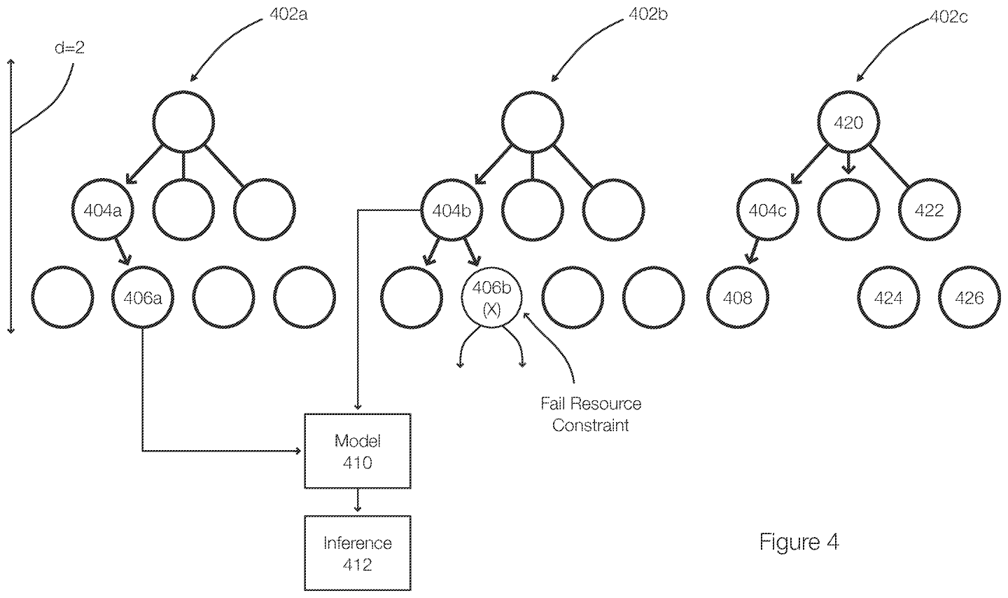

FIG. 4 discloses aspects of cutting operations for cutting a quantum circuit into quantum subcircuits. Directed acyclic graphs can be used to represent quantum circuits. FIG. 4 illustrates an example of a directed acyclic graph at different stages of a cutting operation.

Variables on circuit cutting can be formulated in the following way:

$$\\ {y}_{v , c , h} = \{ \begin{matrix}1 & if vertex v is in subcircuit c \\ 0 & otherwise\end{matrix} and$$

$$\\ {z}_{e , c , h} = \{ \begin{matrix}1 & if edge e is cut by subcircuit c \\ 0 & otherwise\end{matrix} ,$$

where v is the vertex of the DAG, e=(vᵢ, vₒ) is an edge or the qubit wire that links vᵢ and vₒ, and h is the target hardware or the target quantum system, whether real or simulated.

One technique for solving combinatorial problems is branch and bound, where solutions to a combinatorial problem are evaluated on a solution or tree structure. This structure allows all solutions derived from a poor solution to be pruned from the tree in an efficient way. The quality of each of each candidate solution, x, is obtained via an objective function ƒ(x). If a search on a branch and bound scheme is performed where every node is characterized by the fixation of, for example, a variable y_{v,c,h} in 1 or 0, a smaller optimization problem can be solved at every node of the branch and bound tree.

In the case of an example cutting process, ƒ(xᵢ) is related to the cost of post-processing (knitting) the subcircuits represented by candidate solution xᵢ. In some embodiments, ƒ(xᵢ) also considers an estimation of resource consumption of the subcircuits (e.g., how much a circuit is expected to consume in terms of RAM, CPU, time and/or other metrics of interest).

Further, a machine learning model 410 (M), may be trained to learn the relationship between quantum circuit parameters, x, such as number of qubits and depth, and resource consumption telemetry data. At inference time, a new quantum circuit's parameters are obtained and provided to M, which then estimates the amount of RAM, CPU, etc., to be consumed by the execution of the quantum circuit on the simulated quantum computing system.

In one example, every subcircuit resulting from a cutting configuration or operation (the quantum circuits of a particular solution to the cutting problem) may be provided to M, and the maximum amount of resources consumed by any of the subcircuits in a given solution may be use as an estimate for the resource consumption of the configuration or solution.

As stated previously, ƒ(xᵢ) may combine the estimation obtained with M(xᵢ) with the knitting cost of a candidate solution xᵢ. However, this results in the previously discussed conflicting objectives to, at the same time, increase and decrease the number of sub-circuits in xᵢ. To address this, the assessment of M(xᵢ) is separated from ƒ(xᵢ) in embodiments of the invention.

More specifically, a query function Q(\hat{R}|S) can be implemented that serves as a constraint to indicate whether the resources to be consumed by the current cutting configuration (i.e., set of sub-circuits—\hat{R}), can be executed on some target simulation infrastructure (S). Then, the constraint “Q(M(xᵢ)|S)=‘pass’?” may be relaxed for the exploration of every node and verified at every d levels of the nodes in some embodiments of the invention.

The query function can be represented as a pass/fail mechanism to determine whether a particular solution is practical or feasible. As shown in FIG. 4, for d=2, intermediate nodes may not execute model M, but this is not precluded. In one example embodiment, the model M is only executed at certain selected nodes, minimizing the computational burden of executing the model at every node. Then, if the explored node does not satisfy the resource consumption constraint, this node and all children of that node are pruned. Also, a backward verification may be performed. This may allow additional branches to be pruned more efficiently if the constraint is not attained in intermediate nodes. All variables related to the possibility of the cutting configuration being allocated on S is fixed to y_{v,c}=0. This is similar to the so called “lazy constraints” of combinatorial optimization problems.

In the example of FIG. 4, a tree structure is illustrated at different stages represented by 402a, 402b, and 402c. In this example, the depth d=2 and a node 406a is being evaluated. The node 406a corresponds to a particular solution of the cutting problem. The solution is provided to a model 410 and an inference 412 is generated. The inference 412 may include a prediction or estimation of the resources and/or time required to execute the solution in a target quantum computing system, which quantum computing system may be a simulated quantum computing system.

More specifically, the query Q(M(xᵢ)|S) is performed with respect to the node 406a. In this example, the query fails. Thus, Q(M(xᵢ)|S)=‘fail’. As illustrated in the stage 402b, the node (now referenced as 406b) along with all children of the node 406b are pruned from the tree structure.

At the stage 402c, a backward verification (a query) is performed at the node 404c. Thus, the solution to the cutting problem represented by the node 404c is submitted to the model 410 and an inference 412 is generated. Stated differently, the query Q(M(xᵢ₋₁)|S) is performed. If the query fails (the inference is above a threshold level, the node 404c is pruned along with its children nodes including the node 408. If Q(M(xᵢ₋₁)|S)=‘pass’, then the solution remains in the tree structure for consideration.

By way of example, the node 420 may represent an initial solution to a quantum circuit having 10 qubits. Thus, the solution of the node 420 is the quantum circuit. The node 422 may represent a solution that includes two quantum subcircuits (a cut) having 4 qubits and 6 qubits, respectively. If the nodes 424 and 426 are children of the node 422, the solution of the node 424 may include quantum circuits of 2, 2, and 6 qubits. The node 426 may represent a solution of quantum circuits with 4, 3, and 3 qubits.

If the solution of the node 422 is probed using the model 410 and the query fails, the node 422, 424, and 426 would be pruned from the tree structure. This reduces the set of solutions efficiently and allows the cutting solution to arrive at a specific cutting solution more quickly.

Embodiments of the invention thus include resource consumption estimation or inference into the cutting operation as a quality-related restriction. Using a machine learning model to prune solutions based on predicted resource consumption improves the overall efficiency and execution time of the overall cutting operation. Further, embodiments of the invention separate the resource consumption constraint from the cutting optimization objective to avoid conflicts.

Embodiments of the invention thus include resource consumption estimation into the cutting process as a quality-wise restriction: solutions that are unable to satisfy resource consumption requirements are removed from consideration. Thus, a machine learning model can be used while solving a combinatorial optimization problem such as cutting a quantum circuit to prune solutions to the cutting problem based on resource consumption constraints. Further, the separation of the resource consumption constraint from the cutting optimization objective avoid conflicts in its formulation.

Some embodiments of the invention further relate to circuit cutting solutions that focus on or relate to the tasks or running the sub-circuits exclusively on quantum simulation engines. Plus, embodiments of the invention further use resource consumption predictions to eliminate candidate cutting solutions for simulation engines.

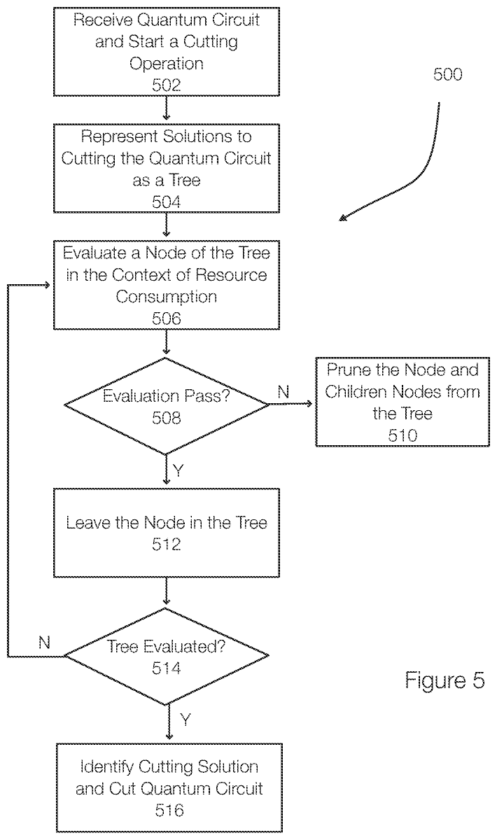

FIG. 5 discloses aspects of a method for performing a cutting operation. The method 500 includes receiving a quantum circuit and starting 502 a cutting operation on the quantum circuit. As previously stated, performing the cutting operation may include solving or finding a suitable solution to a cutting problem. Stated differently, the cutting problem is a combinatorial optimization problem that can potentially consume a substantial amount of time and resources to solve. In the method 500 solutions to cutting the quantum circuit are represented 504 as a tree or solution structure.

Net, a node of the tree is selected and the solution represented by the selected node is evaluated 506 in the context of resource consumption. This allows the solutions to be evaluated at least in terms of quality. Thus, the solution represented by the current node of the tree is provided to a machine learning model that is trained and configured to estimate the resource requirements or resource consumption, execution time, and/or other factors. For example, a query that serves as a constraint may be executed. If the constraint or query passes, the node remains as a potential solution. If the constraint or query fails, the node and its children nodes are pruned or eliminated from the tree and are not considered as solutions to the cutting problem.

Thus, if the evaluation passes (the prediction of required resources and/or execution time is/are below a threshold value) (Y at 508), the node remains in the tree. If the evaluation or query of a node fails (N at 508), then the node and its children are pruned 510 from the tree.

If the nodes have been sufficiently evaluated (Y at 514), a solution is identified from among the solutions remaining the tree and the quantum circuit is cut 516 according to the solution. If the method 500 has more nodes or solutions to evaluate (N at 514), the method 500 selects another node and performs the evaluation or query.

In one example, the model may be executed on a subset of nodes in the tree. The nodes may be selected randomly or in another manner.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid-classical application operations, quantum circuit operations, quantum circuit execution operations, quantum circuit cutting operations, resource consumption estimation operations, quantum circuit knitting operations, telemetry operations, machine learning model operations (e.g., that generate predictions or inferences) or the like or combination thereof. These operations may, in some examples, be referred to as quantum operations.

Example cloud computing environments, which may or may not be public, include storage environments that may provide functionality for one or more clients or systems. Another example of a cloud computing environment is one in which quantum operations and/or quantum services may be performed on behalf of one or more clients, applications, or users. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. The cloud environment may also include quantum environments including vQPUs, QPU, other accelerators, or the like.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data or circuits. Such clients may comprise physical machines, containers, or virtual machines (VMs).

Particularly, devices in the operating environment, such as classical components of hybrid classical-quantum systems, may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in anyway.

Embodiment 1. A method comprising: representing solutions to a cutting problem of cutting a quantum circuit into quantum subcircuits in a tree structure, wherein each node of the tree structure corresponds to a solution of the cutting problem, evaluating a solution associated with a selected node, performing a query on the solution to determine predicted resource requirements of executing the solution in a quantum computing system, pruning the node from the tree structure when the query fails, and leaving the node in the tree structure when the query passes.

Embodiment 2. The method of embodiment 1, further comprising receiving a quantum circuit from a client.

Embodiment 3. The method of embodiment 1 and/or 2, further comprising inputting the solution, which includes a set of quantum subcircuits, into a machine learning model that is configured to predict resource requirements of the set of quantum subcircuits and/or an execution time for the set of quantum subcircuits.

Embodiment 4. The method of embodiment 1, 2, and/or 3, wherein the predicted resource requirements are compared to threshold resource requirements, wherein the solution is rejected when the comparison fails, wherein the comparison fails when the predicted resource requirements are greater than the threshold resource requirements.

Embodiment 5. The method of embodiment 1, 2, 3, and/or 4, further comprising deleting the node associated with the solution and children nodes of the node associated with the solution from the tree structure when the query fails.

Embodiment 6. The method of embodiment 1, 2, 3, 4, and/or 5, further comprising comparing the predicted execution time with a threshold execution time, wherein the comparison fails when the predicted execution time is greater than the threshold execution time.

Embodiment 7. The method of embodiment 1, 2, 3, 4, 5, and/or 6, wherein the query is a constraint indicating whether resources to be consumed by the solution can be executed on a target simulated quantum computing system.

Embodiment 8. The method of embodiment 1, 2, 3, 4, 5, 6, and/or 7, wherein less than all of the nodes in the tree structure are subject to the query.

Embodiment 9. The method of embodiment 1, 2, 3, 4, 5, 6, 7, and/or 8, further comprising performing a backward verification on a parent node of the selected node by performing a query on the parent node.

Embodiment 10. The method of embodiment 1, 2, 3, 4, 5, 6, 7, 8, and/or 9, further comprising, after an operation of pruning the tree is completed, selecting a solution and cutting the quantum circuit according to the solution to generate the quantum subcircuits, wherein finding a solution to the cutting problem is separate and independent of performing a knitting operation after the quantum circuits have been cut and executed at one or more quantum computing systems.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-12.

Embodiment 13. A system comprising a processor and memory configured to perform the operations, methods, or processes, or any portion of any of these, or any combination thereof disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent, may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein, may take the form of, or include, or be implemented on, or hosted by, a physical computing device, As well, where any of the aforementioned elements comprise or consist of a virtual machine (VM) or a container, that VM or container may constitute a virtualization of any combination of the physical components disclosed herein.

In a physical computing device includes a memory which may include one, some, or all, of random-access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein. The physical device may be an example of a classical computing system that may be part of a hybrid computing system. A quantum processing system or unit may also be included in the hybrid computing system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
representing solutions to a cutting problem of cutting a quantum circuit into quantum subcircuits in a tree structure, wherein each node of the tree structure corresponds to a solution of the cutting problem;
evaluating a solution associated with a selected node;
performing a query on the solution to determine predicted resource requirements of executing the solution in a quantum computing system;
pruning the node from the tree structure when the query fails; and
leaving the node in the tree structure when the query passes.

2. The method of claim 1, further comprising receiving a quantum circuit from a client.

3. The method of claim 1, further comprising inputting the solution, which includes a set of quantum subcircuits, into a machine learning model that is configured to predict resource requirements of the set of quantum subcircuits and/or an execution time for the set of quantum subcircuits.

4. The method of claim 3, wherein the predicted resource requirements are compared to threshold resource requirements, wherein the solution is rejected when the comparison fails, wherein the comparison fails when the predicted resource requirements are greater than the threshold resource requirements.

5. The method of claim 4, further comprising deleting the node associated with the solution and children nodes of the node associated with the solution from the tree structure when the query fails.

6. The method of claim 5, further comprising comparing the predicted execution time with a threshold execution time, wherein the comparison fails when the predicted execution time is greater than the threshold execution time.

7. The method of claim 1, wherein the query is a constraint indicating whether resources to be consumed by the solution can be executed on a target simulated quantum computing system.

8. The method of claim 1, wherein less than all of the nodes in the tree structure are subject to the query.

9. The method of claim 1, further comprising performing a backward verification on a parent node of the selected node by performing a query on the parent node.

10. The method of claim 1, further comprising, after an operation of pruning the tree is completed, selecting a solution and cutting the quantum circuit according to the solution to generate the quantum subcircuits, wherein finding a solution to the cutting problem is separate and independent of performing a knitting operation after the quantum circuits have been cut and executed at one or more quantum computing systems.

11. A non-transitory storage medium having stored therein instructions that are executable by one or more hardware processors to perform operations comprising:
representing solutions to a cutting problem of cutting a quantum circuit into quantum subcircuits in a tree structure, wherein each node of the tree structure corresponds to a solution of the cutting problem;
evaluating a solution associated with a selected node;
performing a query on the solution to determine predicted resource requirements of executing the solution in a quantum computing system;
pruning the node from the tree structure when the query fails; and
leaving the node in the tree structure when the query passes.

12. The non-transitory storage medium of claim 11, further comprising receiving a quantum circuit from a client.

13. The non-transitory storage medium of claim 11, further comprising inputting the solution, which includes a set of quantum subcircuits, into a machine learning model that is configured to predict resource requirements of the set of quantum subcircuits and/or an execution time for the set of quantum subcircuits.

14. The non-transitory storage medium of claim 13, wherein the predicted resource requirements are compared to threshold resource requirements, wherein the solution is rejected when the comparison fails, wherein the comparison fails when the predicted resource requirements are greater than the threshold resource requirements.

15. The non-transitory storage medium of claim 14, further comprising deleting the node associated with the solution and children nodes of the node associated with the solution from the tree structure when the query fails.

16. The non-transitory storage medium of claim 15, further comprising comparing the predicted execution time with a threshold execution time, wherein the comparison fails when the predicted execution time is greater than the threshold execution time.

17. The non-transitory storage medium of claim 11, wherein the query is a constraint indicating whether resources to be consumed by the solution can be executed on a target simulated quantum computing system.

18. The non-transitory storage medium of claim 11, wherein less than all of the nodes in the tree structure are subject to the query.

19. The non-transitory storage medium of claim 11, further comprising performing a backward verification on a parent node of the selected node by performing a query on the parent node.

20. The non-transitory storage medium of claim 11, further comprising, after an operation of pruning the tree is completed, selecting a solution and cutting the quantum circuit according to the solution to generate the quantum subcircuits, wherein finding a solution to the cutting problem is separate and independent of performing a knitting operation after the quantum circuits have been cut and executed at one or more quantum computing systems.
